(19) United States
(12) Patent Application Publication
(10) Pub. No.: US 2002/0035512 A1
(43) Pub. Date: Mar. 21, 2002

(54) Method of retail shopping including establishment-specific intranet and special purpose customer assistance cash register and intranet

(76) Inventor: Ronald J. Pavlik, Fort Lauderdale, FL (US)

Correspondence Address: MELVIN K. SILVERMAN, 4901 N. FEDERAL HWY., SUITE 410, FT. LAUDERDALE, FL, 33308, US

(21) Appl. No.: 09/784,148

(22) Filed: Feb. 16, 2001

Related U.S. Application Data
(60) Provisional application No. 60/183,163, filed on Feb. 17, 2000.
(60) Provisional application No. 60/210,799, filed on Jun. 12, 2000.

(51) Int. Cl. G06F 17/60

(52) U.S. Cl. 705/26

(57) ABSTRACT

A method of retail shopping includes the step of assigning an establishment specific shopper profile to each customer and digitally expressing the same as an intranet access means which may be electronically encrypted into the shopper's store charge card. In the retail establishment, the method includes the step of selecting a product search mode from the product search mode possibilities consisting of physically looking at a product display and touching it, observing a static, dynamic, or other pre-defined electronic image or series thereof including store department-specific images, or proceeding to an intelligent shopping station (ISS) comprising the establishment intranet and accessing the intranet with the intranet access means. If the ISS is employed by the shopper, a graphical user interface (GUI) is activated. The customer may access product specific information within searchable databases of the ISS selected from suggestion categories consisting of product information, frequently asked questions about a consumer-indicated product, alternatives to the indicated product, coordinates suitable therewith, and combinations thereof. The step of accessing suggestion categories includes the step of sorting each category in accordance with one or more criteria including geographical region, season, age of shopper, other personal data profile of the shopper, price range of interest, current discounts, random, and priorities of management. Some of such sorting may be more readily accomplished by the intranet access means if the shopper or establishment has included category-specific information within the shopper's electronic profile.

### REFERENCE TO RELATED APPLICATION

This case is a non-provisional, utility application conversion of Provisional Application Ser. No. 60/183,163, filed Feb. 17, 2000, and No. 60/201,799, filed Jun. 12, 2000. The benefit thereof under 35 U.S.C. 119(e) is claimed and the subject matter thereof incorporated by reference into this application.

### BACKGROUND OF THE INVENTION

The present system provides a novel link between hands-on retailing and home catalog/Internet/home TV shopping in which many of the benefits of such forms of home shopping are integrated into a sales floor environment within a retail establishment.

The instant invention thereby addresses a long-felt need on the part of retail establishments to respond to increasing competition from the above noted forms of e-tailing and home shopping and, as well, to integrate the advantages to both consumer and retailer of store-site shopping with the advantages of on-line and other forms of home shopping to thus inform, educate, expedite sales, and deliver products in a depth and range not heretofore possible.

The invention derives from a realization that the contemporary consumer has less time to shop, demands better service, and has reduced tolerance for low inventory with respect to issues of size, color and assortment. See Block A of FIG. 1. Conversely, the present invention responds to needs of traditional retailers in presenting new product ideas and emerging trends as effectively as on-line businesses, in efficiently relating product enhancements and accessories to individual product sales, in providing efficient delivery of goods, and by enabling the potential of group purchases and group promotions. See Block B of FIG. 1. The present system and method, commercially known as TOTALSHOP, may therefore be considered as a bridge between hands-on retailing and home catalog/internet shopping. Therein, its purpose is to inform, educate, expedite sales, and deliver products in a depth and variety not heretofore possible. Resultant thereof (see Block A1 of FIG. 1) the consumer may be provided with unlimited inventory, colors and assortment; may be educated with instant product information; may be provided with a tactile and real shopping experience; and may be provided with the benefit of speed and delivery associated with internet and catalog shopping. Concurrently (see Block B1 of FIG. 1), retailers obtain a vehicle with visionary imagination to new and prospective products, are transformed from a warehouse mentality into a diverse world of product ideas that can be constantly modified and updated, and are provided with the benefits and scope of internet shopping without loss of the tradition and intimacy of hands-on shopping.

The prior art as best known to the within inventor is reflected in U.S. Pat. No. 5,434,394 (1955) to Roach, et al, entitled Automated Order and Delivery System and U.S. Pat. No. 5,970,493 (1999) to Gerszberg, et al, entitled Video Communications Device Providing In-Home Catalog Services. The system of Roach teaches integration of the order and delivery of retail merchandise, which includes an automated system for combining point of sale and warehouse processing functions in the selection, order, and delivery of merchandise. The system of Roach is particularly applicable in integrated point of sale and warehouse facilities such as hard good megastores of the type of Brandsmart and Circuit City where, because of the size, quantity, and value of the merchandise, only a limited amount of such merchandise is available for display in the retail area. Accordingly, in such facilities, a need has arisen to establish an information-based flow of activity which satisfies both the customer shopping experience and the requirement of the retailer to allow a suitable warehouse processing function while enabling efficient merchandise selection and delivery thereof either at a pick-up location within the warehouse facility or through accomplishment of a warehouse originated delivery of the purchased items. The present invention attempts to apply certain concepts of Roach, to general merchandise stores, selling primarily soft goods and in a much greater number and variety than is contemplated in systems of the type of Roach above.

The above reference to Gerszberg relates to an earlier generation of e-tailing which, essentially, constitutes a communication system for enabling catalog-related sales and services, the same including display means, input means for receiving on-line customer orders, auto processing means, and a centralized database service corresponding in content to that of an in-home catalog accessible by the e-commerce customer from his personal computer. In other words, Gertzberg relates to early forms of Internet use for purposes of e-commerce.

Also of interest to the instant invention is U.S. Pat. No. 5,047,614 (1991) to Bianco, entitled Method and Apparatus for Computer Aided Shopping. Bianco teaches the use of a portable bar code scanner having an electronic memory. Through the use of such a bar code scanner, a customer may scan into the memory of the portable device one or more bar codes from bar code tags or labels within a store for purposes of later use of this information as part of a larger computer-aided shopping system.

### SUMMARY OF THE INVENTION

The within invention relates to a method of retail shopping including an establishment-specific intranet. This method includes the step of assigning an establishment specific shopper profile to each customer and digitally expressing the same as an intranet access means which may be electronically encrypted into the shopper's store charge card. In the retail establishment, the method includes the step of selecting a product search mode from the product search mode possibilities consisting of physically looking at a product display and touching it, observing a static, dynamic, or other pre-defined electronic image or series thereof including store department-specific images, or proceeding to an intelligent shopping station (ISS) comprising said establishment intranet and accessing said intranet with said intranet access means. If the ISS is employed by the shopper, a graphical user interface (GUI) is activated. Thereat, the customer may access product specific information within searchable databases of said ISS selected from suggestion categories consisting of product information, frequently asked questions about a consumer-indicated product, alternatives to the indicated product, coordinates suitable therewith, and combinations thereof. The step of accessing suggestion categories includes the step of sorting each category in accordance with one or more criteria including geographical region, season, age of shopper, other personal data profile of the shopper, price range of interest, current discounts, random, and priorities of management. Some of such sorting may be more readily accomplished by said intranet access means if the shopper or establishment has included category-specific information within the shopper's electronic profile.

The invention also relates to a cash register or cashwrap system inclusive of a customer assistance intranet. The cashwrap portion thereof, also termed said ISS includes computer means for the display and reading of information from a digitally or optically readable tag. Also, information may be inputted into the workstation from a computer mouse or keyboard associated therewith. In one embodiment, the workstation includes dual user monitors or screens, one for the customer and the other for a sales assistance. Upon each screen initially appears said GUI. Such workstation is situated upon the sales floor of a department store or other retail establishment.

In one mode of operation, the system requires a digitally or optically readable tag associated with a unit of merchandise of potential interest to the customer, the tag including thereupon information sufficient to identify such merchandise with which the tag is associated. As above noted, the system also includes databases accessible from either said GUI or by digitally scanning said tag into the workstation. One database is organized relative to quantity, sizes, and colors of the item of the scanned tag. Another database includes visual suggestions regarding coordinating merchandise, such as accessories, and possible alternative merchandise, as developed from a customer profile database. The system further includes program means, in digital communication with said work station, for processing payment and effecting direct customer delivery from a remote location of merchandise not in stock at the local establishment to any address designated by a customer at a time of purchase or to an address already resident within the customer profile database.

It is accordingly an object of the invention to provide to traditional retailers a sales floor environment including many of the benefits of forms of home shopping inclusive of Internet, home TV shopping channels and home catalog.

It is another object to provide a means to respond to the long-felt need of retail establishments to increasing competition from the above noted forms of e-tailing.

It is a further object of the invention to provide a system to enable retailers to respond to new product ideas and emerging trends as effectively as on-line businesses.

It is a still further object to provide a cash register/intelligent shopping station of the above type to provide to the customer reduced shopping time, superior service, and access to a wider variety or size, color, quantity, and coordinates than is available in existing retail establishments.

It is a yet further object to provide a system of the above type in which suggestions to the consumer of size, color, style, and price range are provided within the context of a database of personal profiles of membership/store credit card holders of the particular establishment.

It is a still further object of the invention to provide a system of the above type in which visual suggestions relative to alternatives, coordinates, region, season, age, price, and style are available to the consumer, either with or without intervention of a sales assistant, thereby enabling retail establishments to respond to a range of interest and to provide a degree of personalization comparable to that of Internet e-commerce sites.

The above and yet other objects and advantages of the present invention will become apparent from the hereinafter set forth Brief Description of the Drawings and Detailed Description of the Invention set forth herein.

### BRIEF DESCRIPTION OF THE DRAWINGS

FIG. 1 is a diagram setting forth consumer/retailer needs to which the instant invention is responsive, as well as the benefits of the invention to both consumer and retailer.

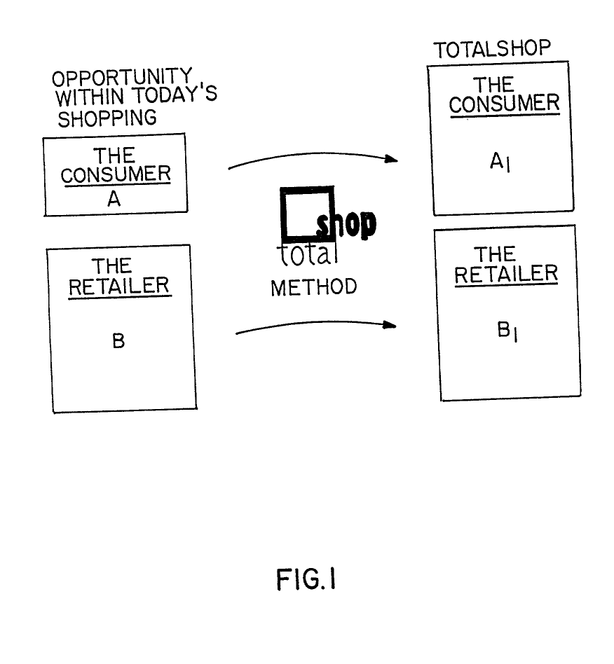

FIG. 2 is a vertical cross-sectional conceptual view of a dual screen cash register of an interactive shopping station in accordance with the present invention.

FIG. 3 is a top schematic view of one embodiment of an interactive shopping location.

FIG. 4 shows a first embodiment of a standalone interactive customer station having keyboard and store credit card scanning capability.

FIG. 5 shows another embodiment of a standalone customer station in which an optical code scanning and mouse input capability have been added thereto.

FIG. 6 is a schematic systems diagram of the present invention.

FIG. 7 is a decision tree diagram showing possible steps and options of a customer using the interactive shopping system.

FIG. 7A is a flow diagram of the inventive method.

FIG. 7B is a diagram of a data object model of a database structure applicable to the intranet aspect and usable with Steps E1 to E6 of FIGS. 7 and 7A.

FIG. 8 is a diagram providing an overview of the manner of use of the system by corporate management and the manner of communication of information from management, to operating divisions, to retail locations, and to the customer.

FIG. 9 comprises a written and graphical summary of the present system.

FIG. 10 sets forth typical displays provided by the present system, and includes a customer template applicable to apparel coordinating options.

FIG. 11 illustrates a zoom capability of the display of FIG. 10 in which one of the product concepts thereof has been enhanced while permitting the user to see the other product or coordination options relative to the same merchandise area.

FIG. 12 is a visual presentation option within the present system in which a department of a retail establishment appears as a template, and in which selected areas or subjects thereof, may be visually enhanced to, optionally, feed into screen displays of the type of FIGS. 10 and 11.

FIG. 12A is a flow chart summarizing the functions of the screens of FIGS. 9 to 12 above, reflective to the flow chart of FIG. 7A.

FIG. 13 is an illustration of physical display of merchandise items within a retail store in which the store is substantially configured for purposes of merchandise display, as opposed to purposes of merchandise inventory, thereby maximizing the types and styles of merchandise items for which retail floor space may be utilized.

FIG. 14 is an illustration showing the use of high-resolution LED screens to display merchandise and TOTALSHOP user screens upon walls of the retail establishment.

### DETAILED DESCRIPTION OF THE INVENTION

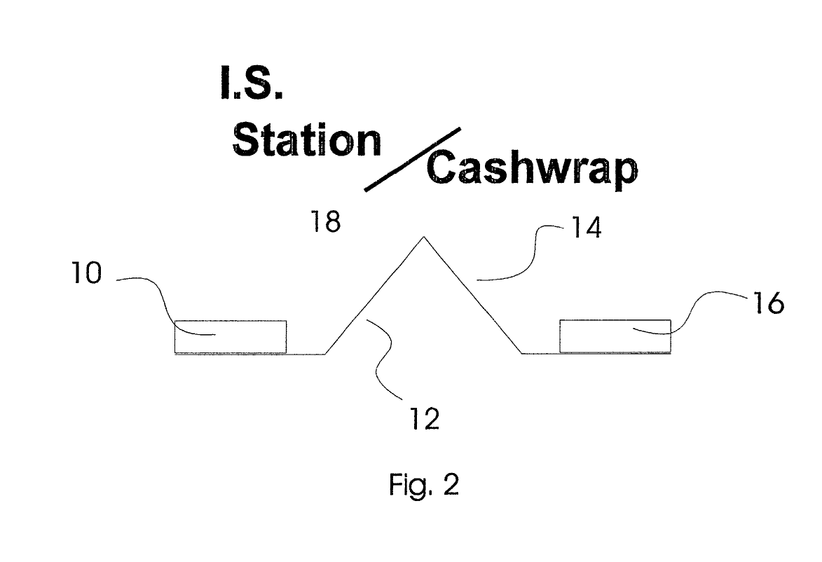

With reference to the conceptual view of FIG. 2, there is shown the use of a dual screen, dual input interactive shopping station which, as well, functions as a cashwrap or cash register location 18 within the concept of the TOTALSHOP facility set forth herein. For purposes of the present description, the TOTALSHOP customer assistance person is referred to as the Cruise Director. Accordingly, in FIG. 2 is shown Cruise Director data input means 10, a Cruise Director screen 12, a customer screen 14, and customer data input means 16.

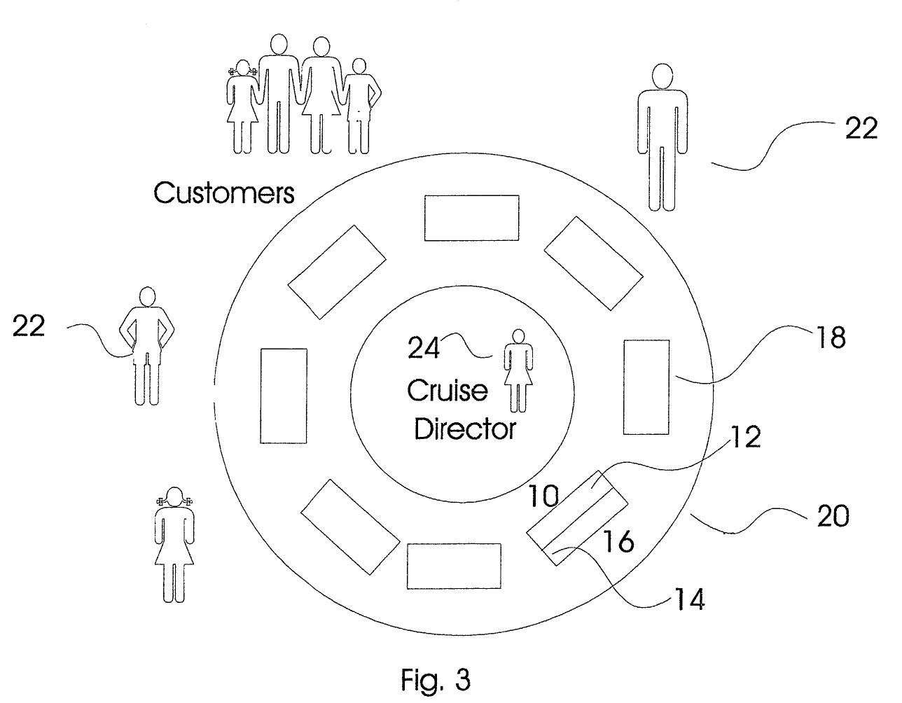

In FIG. 3 is shown one form that interactive TOTAL SHOP station or cash register/cashwrap may take in the context of the present invention. Therein, an interactive shopping station 18 may be positioned within a kiosk 20, which may employ any of a number of forms, not limited to the annular geometry shown in FIG. 3. For example, a semi-circular or linear geometry may prove entirely functional as kiosk 20. However, regardless of geometry, the interactive shopping station, in the embodiment of FIGS. 2 and 3, contemplates that a customer 22 is located opposite one side of the cashwrap location 18 while Cruise Director 24 is located at the opposite side thereof.

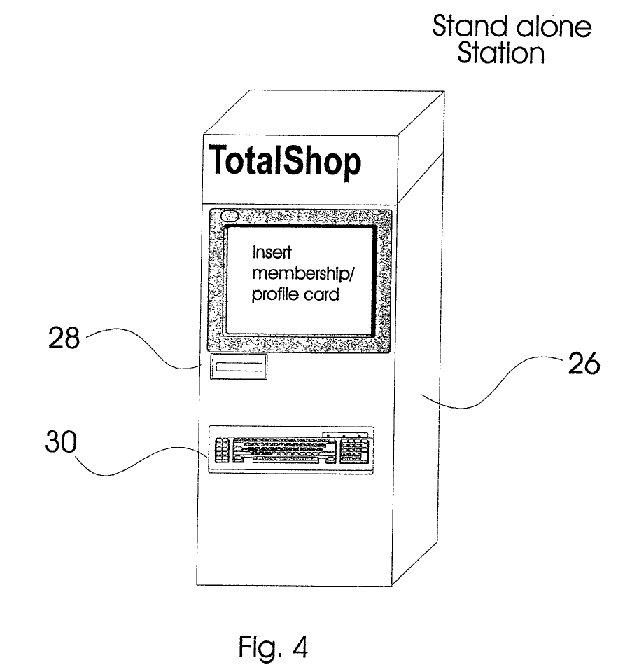

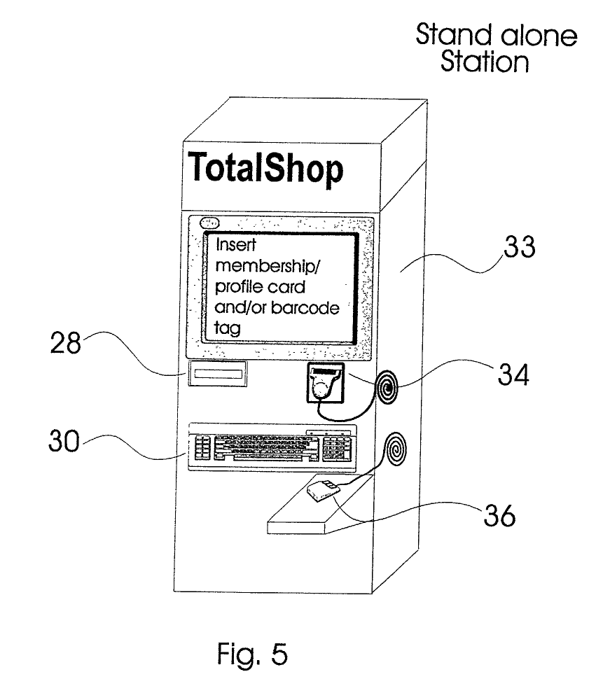

Alternate embodiments of an interactive shopping station within the contemplation of the present invention are shown in FIGS. 4 and 5. More particularly, shown is a standalone TOTALSHOP station 26. Its operation requires only a membership or store credit card, either of which would preferably include a digital customer profile, which is inserted into slot 28. Accordingly, at the standalone station 26 of the type shown in FIG. 4, the customer is able to obtain a variety of generalized information, as is more fully described below, about merchandise of potential interest available from the particular retail establishment.

In FIG. 5 is shown a more fully equipped standalone shopping station 32 which includes a bar code reader 34 and a mouse 36. The embodiments of FIGS. 4 and 5 are particularly applicable to customers who have become familiar with the TOTALSHOP system and do not, as that time, require the assistance of the Cruise Director. It is contemplated that standalone units of the types of FIGS. 4 and 5 may be more department-specific than the dual screen embodiments of FIGS. 2 and 3.

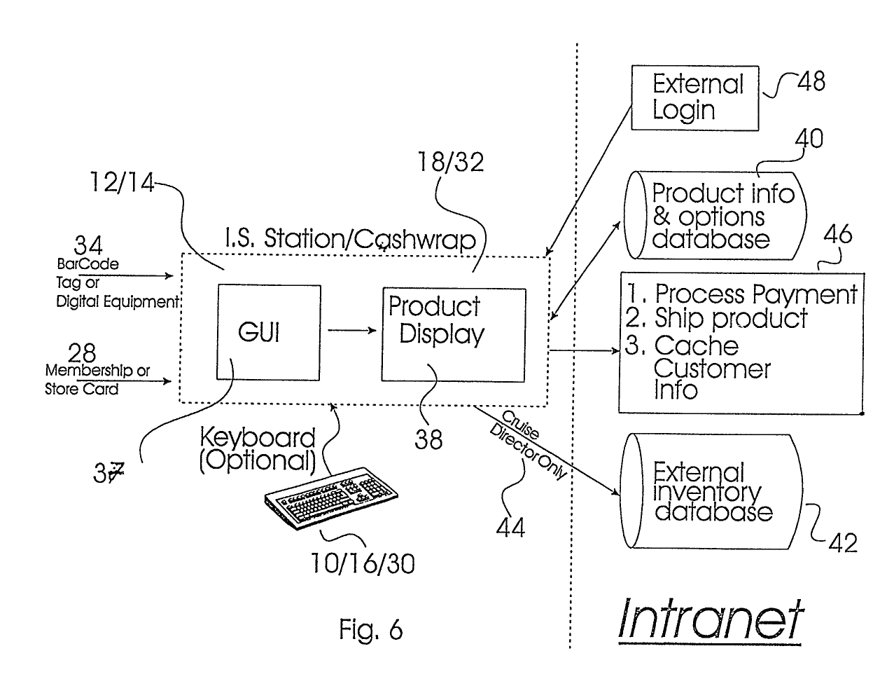

In FIG. 6 is shown a system overview of the interactive shopping station with customer-assisting intranet. Therein, the shopping station 18/32 includes said membership or store card reader 28 and said bar code tag reader 34 or a digital equivalent thereof. Further, a mouse and/or keyboard 10/16/30 is provided. However, regardless of the input means, there is provided a graphical user interface (GUI) 37 from which a variety of products display 38 (more fully described below) may be effectuated. Such displays will typically come from database 40 which provides access to a variety of product information and options. There is also provided an external inventory database 42, which typically is accessible only by the Cruise Director through link 44. Accordingly, through the external inventory database 42, the Cruise Director can determine nationwide availability of given products relative to size, color and quantity thereof.

Block 46, as a further part of the intranet aspect of the invention, provides for payment processing, product shipping, and the acquisition of customer information for purposes of addition to a personal profile of each customer.

Shown at block 48 is an external log-on capability of the system, this for the benefit of customers who wish to research a particular subject or product in the comfort of their home or office, or thru wireless online means, prior to, or even while, visiting the retail establishment, or to place an order while online, thereby providing direct competition to e-tailers.

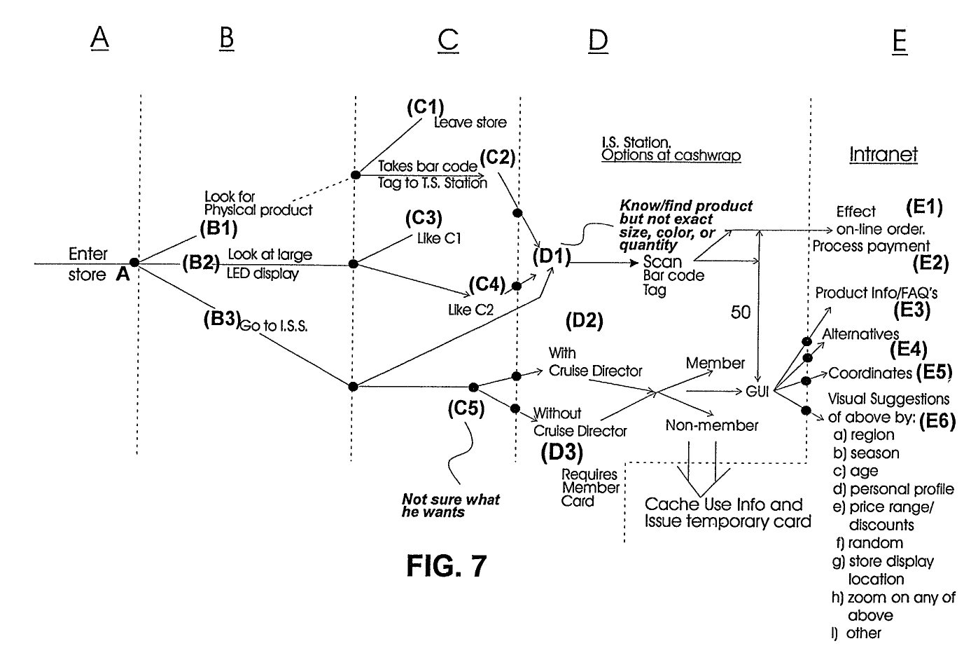

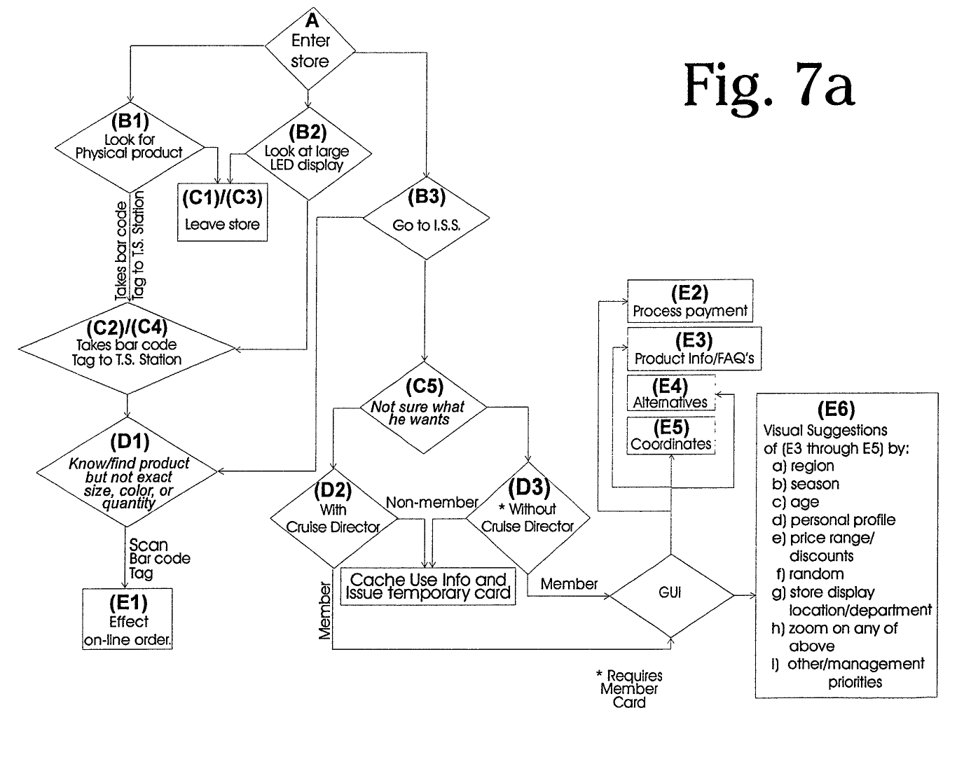

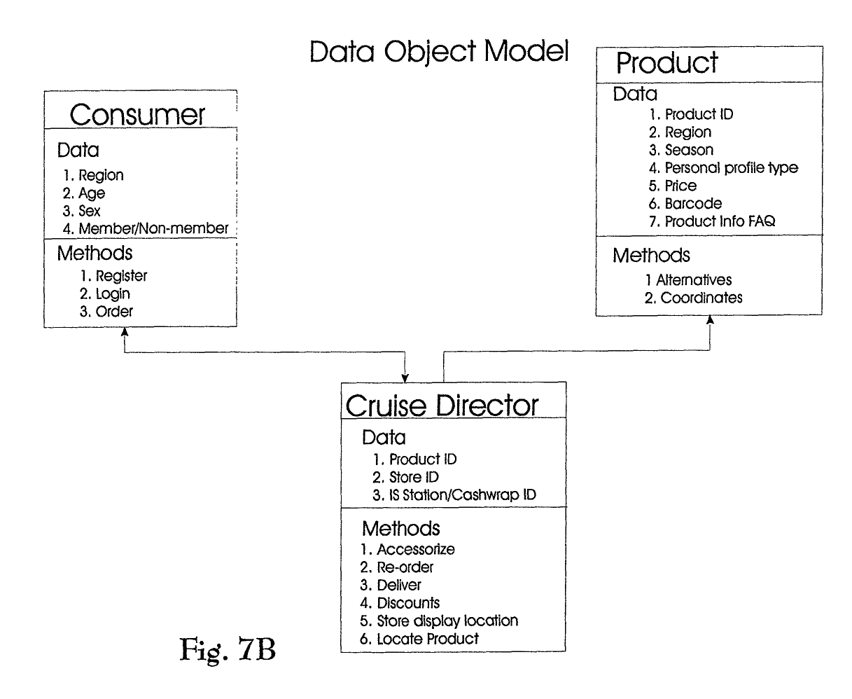

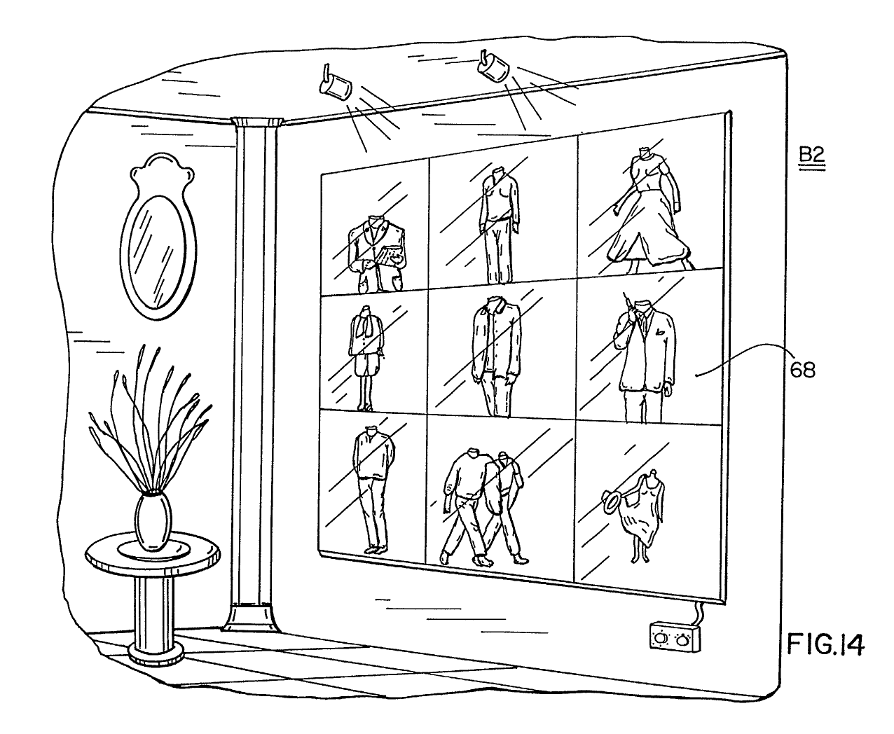

With reference to FIG. 7, there is shown a decision tree diagram of the various steps and options which occur in the TOTALSHOP system. More particularly, Column A of the flow diagram of FIG. 7 indicates the customer entering the store. After such entrance, the customer will typically have three Column B options, namely, Option B1 in which the customer looks at the physical product, Option B2 in which the customer observes a large high resolution LED display or video of the product (described more fully with reference to FIG. 14 below) and Option B3 in which the customer goes directly to an interactive shopping station (ISS) 18 or 32.

Continuing to Column C of the decision tree diagram, if the customer has selected Option B1, two possibilities then ensue, namely, Option C1 in which the customer leaves the store (for whatever reason) and Option C2 in which the customer takes the bar code tag to an interactive shopping station. Further shown in column C are the options which follow from B2 which, as may be noted, are substantially identical to those which follow Option B1. In either case, the customer will, in all likelihood, not have the physical product in hand but, rather, will simply hold a bar code tag or a bar code card created in accordance with scanning technology of the type of U.S. Pat. No. 5,047,614 to Bianco, referenced above in the Background of the Invention.

Option C5 in Column C of the flow diagram corresponds to a shopper who is not certain of what he or she wants. Thereby Option C5 will follow Option B3, except where the shopper enters the store knowing exactly what he wants, in which case, Step D1 (see below) would follow Option B3.

Moving forward to Column D of the flow diagram, from Option C2 or C4, the shopper proceeds to Step D1. This corresponds to the common retail store situation in which a customer has identified a product of interest but is unable to find that product in the exact size, color, or quantity desired. In this scenario, the customer scans the bar code tag or inputs digitally equivalent data, whereupon information regarding product availability with respect to various sizes, colors, and quantity will appear upon product display screen 38. This information is drawn from databases 40 and 42. Therefrom, the customer is able to indicate, using the keyboard, mouse, or touch screen capability of the GUI 37. The exact size, color(s) and quantity desired of the product for which the bar code tag has been inputted. This will result in accomplishment of an on-line order (E1 of Column E) as well as payment processing at E2 of the flow diagram.

However, after a customer has completed such an on-line order and payment, one may then employ link 50 (see Column D of FIG. 7) to connect to the GUI 37 to obtain information with respect to other products, this in a fashion below-referenced with respect to Options D2 and D3 of system. More particularly, in Options D2 and D3, the customer many “navigate” either with (D2) or without (D3) the assistance of the Cruise Director, whether or not one holds a company credit card or some other form or establishment identification card. In the event that a customer, coming out of either Option D2 or D3, is a non-member, customer profile information is secured/cached for such an individual and, thereupon, a temporary membership card is issued. In any event, either Option D2 or D3 leads to the GUI 37 of the interactive shopping station 18 or 32 (as above defined). Thereupon, a variety of product information and option functions become accessible to the shopper, these including product information and frequently asked questions (FAQs) about a particular product (E3), product alternatives (E4), product coordinates (E5), and visual suggestions (E6) in regard to the above and other categories. Such suggestions are accessible in relation to one or more of the following:

Region, season, age of customer, personal profile already in the store database, price range/discounts, random, other information believed by management to be of interest to certain customers, store department or display location with respect to particular products, and zoom capability with respect to any visual image of the above by subject or category. Accordingly, the complex multi-level linked menus of E6 (a) thru (i) may also be accessed from the E3, E4 and E5 functions using product information and option database 40.

A flow diagram of the above decision tree is shown in FIG. 7A and an object model of databases applicable to the functions El to E6 above are shown in FIG. 7B.

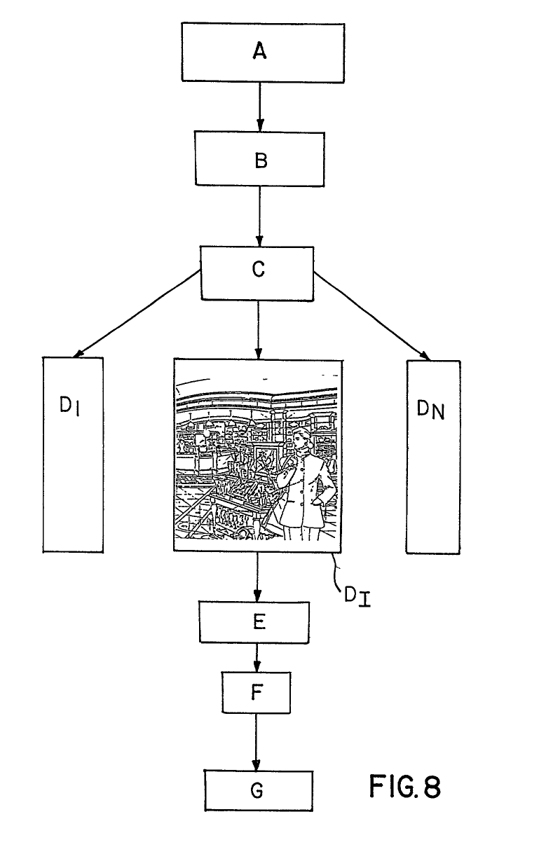

With reference to FIG. 8, there is provided an overview of the manner of use of the TOTALSHOP system by corporate management and communication of information from upper management, to operating divisions, to retail store locations and, ultimately, to the TOTALSHOP customer. This information appears for most part, as changes or modifications within the product information and options database 40, that is, a part of the TOTALSHOP intranet. This information would in turn be specifically available to the consumer as functions E3 through E6 of Column E of the diagrams above described with reference to FIG. 7 and 7A. Accordingly, it is to be noted that the TOTALSHOP intranet provides a means by which management can rapidly respond to regional, seasonal, price, style, and other vital issues within the retail environment, this all in the context of a visually dynamic store.

FIG. 8 more particularly sets forth the concept (Block A) that the TOTALSHOP program includes both software and hardware technology and a specific method or process for the use thereof. Therein, originating at corporate headquarters (Block B), it provides means by which a consistent multi-location corporate vision may be implemented. Therein, products are presented and displayed with their respective enhancements, accessories, and product information, all upon a dynamic graphic backdrop. Block C indicates that this information, in both alpha-numeric and visual terms, can be instantly relayed to each division D1 through DN of the company. A sample of such an image is shown in Block D1 which, in such illustration, provides to every division in a retail organization (comprising potentially hundreds of geographically dispersed locations) the manner in which central management wishes a particular department to appear and the location-present, new or proposed-of merchandise therewith. Therein (see Block E of FIG. 8) the TOTALSHOP program furnishes a strong visual tool that is built around said ISS located at a cashwrap area (more fully described with reference to FIGS. 2 and 3 above). Therein, the customer may secure information with respect to alternative sizing, colors, and coordinating merchandise. Block F indicates that purchases may be automatically forwarded to any destination of the customer's choice inclusive of home, office, or geographically remote friends and family members. Therein, and as is reflected in Block G, the TOTALSHOP solves many customer problems inclusive of those associated with lack of inventory of the exact size, color and quantity of a given product sought by a customer at a particular retail location.

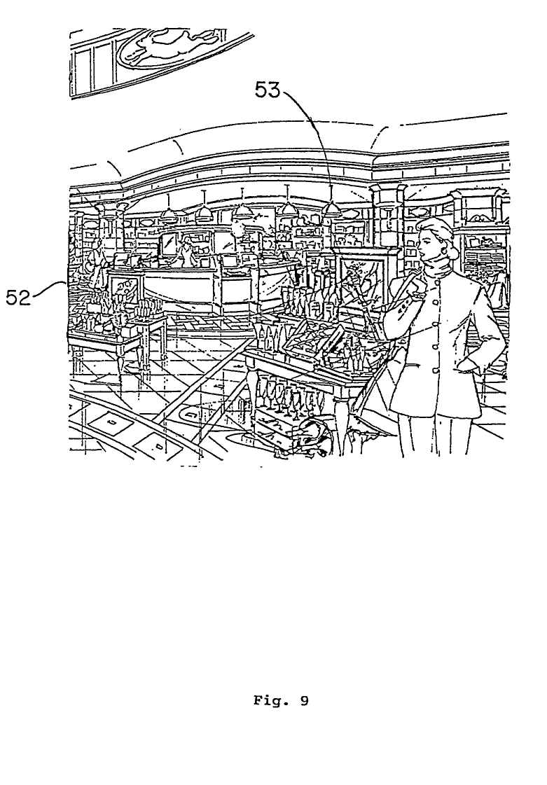

With reference FIG. 9, an ISS product display of search category (E6) (g), i.e., a store display site 52 is shown that includes much greater availability of space and application of design and imagination to provide an experience of education and inspiration at the point of purchase (actual or online) while providing access to specific size, colors and quantity of product available from remote warehousing locations (see FIG. 6, database 42). Accordingly, a customer wishing to “click” upon a particular item 53, shown in the store display template of FIG. 9 simply uses a cursor at the ISS to click on that item. See FIGS. 5 and 6. Thereafter, the shopper can use the E3, E4, or E5 functions for more information on the item 53 or a related product.

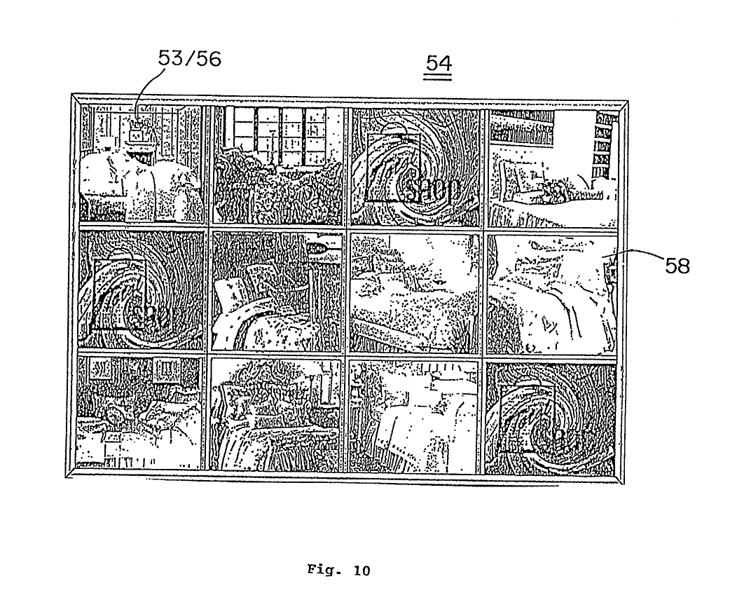

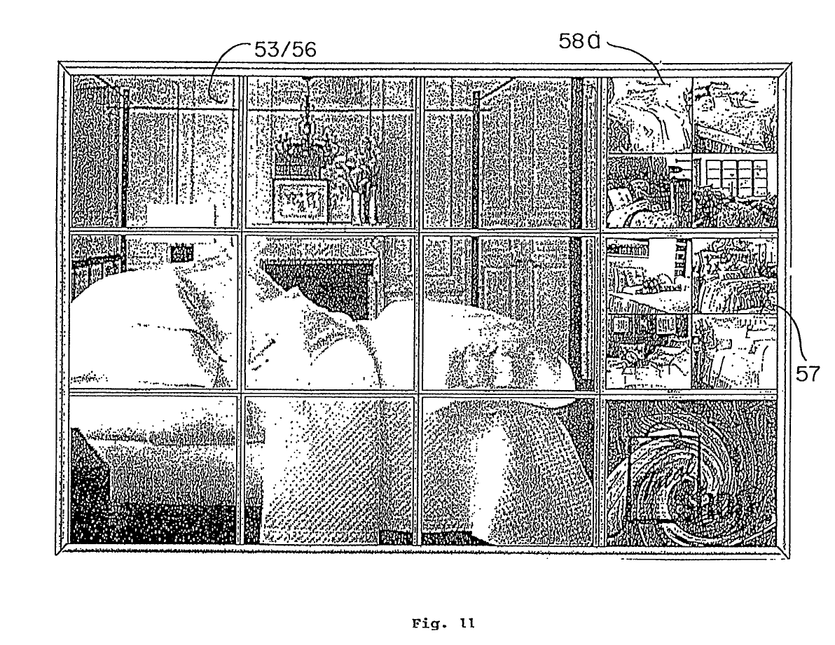

In FIG. 10 is shown a typical product category display 54 accessible under functions E4, E5 or E6 of the TOTALSHOP system. As may be noted therein, such visual displays/suggestions will randomly display product ideas 58 within a given category until the customer chooses to zoom upon one of the images 56 of FIG. 10 whereupon the GUI screen will shift to FIG. 11 in which products alternatives or coordinates 58a will then appear in smaller size at one side of the display screen. Therein, the shopper is able to focus upon aspects of the single product 53 while still viewing alternatives, coordinates, or suggestions that may be available within the particular product category. There, a product of interest 57 may be clicked upon.

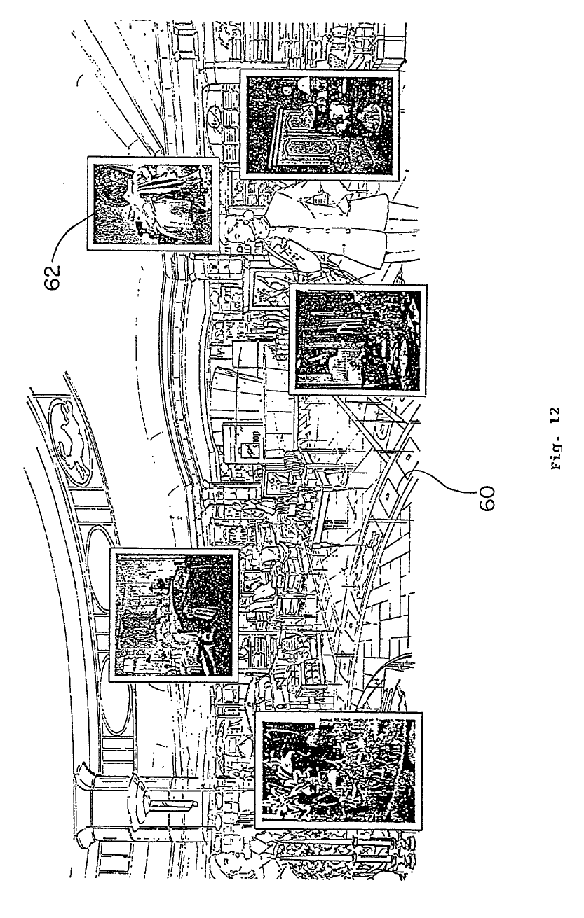

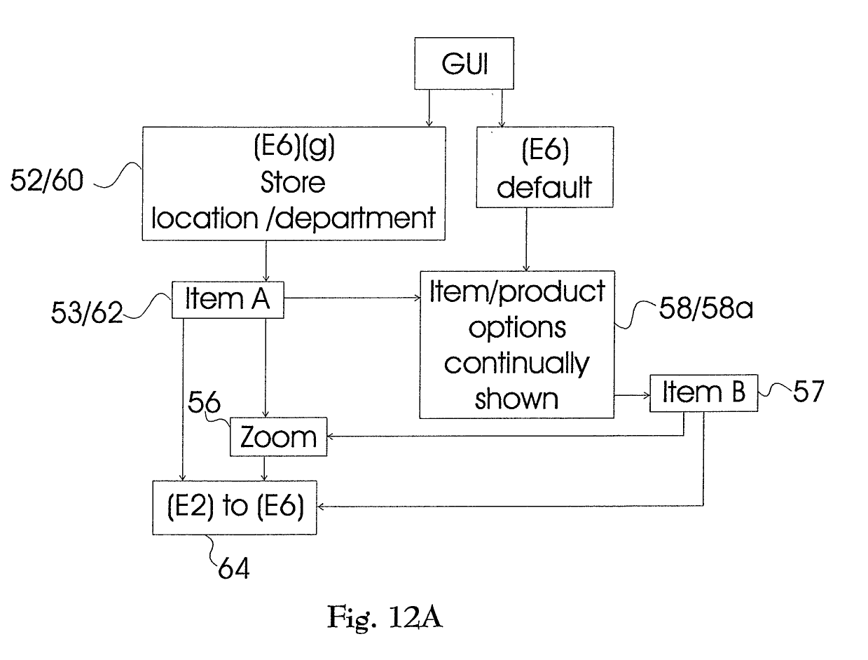

In FIG. 12 is shown the ability of the system to zoom in upon a particular area 60 of a floor of the retail establishment. In other words, the consumer by clicking on one of the pictures 62 in FIG. 12, will then be brought to the display screens 56/58a of FIG. 11 from which, should a customer wish, he may click upon any of the alternative or coordinate suggestions 57 shown in the smaller images thereupon. Alternatively, after the TOTALSHOP customer has clicked upon one of the images 62 in FIG. 12, he may then click upon any of the categories of E6 (see Block E6 of FIG. 7A) to particularize any image of FIGS. 10 or 11 in accordance with considerations of region, season, age, personal profile, pricing, or discount status. In other words, a screen of the type of FIG. 11 will itself display various coordinates within a product area. These coordinates will typically be so extensive that it will be necessary for the TOTALSHOP customer to then click on E6 to a linked list or menu to limit the number of sub-displays. See Block 64 of FIG. 12A. That is, the customer is able to reach the visual suggestions of the menu of E6 either directly from the GUI, as a linked list/menu off of E3 (product information), E4 (alternatives), or E5 (coordinates), or off of a “clicked” picture 53, 57, 58, 58a or 62.

The above functions shown in FIGS. 9 to 12 are summarized in the flow diagram of FIG. 12A.

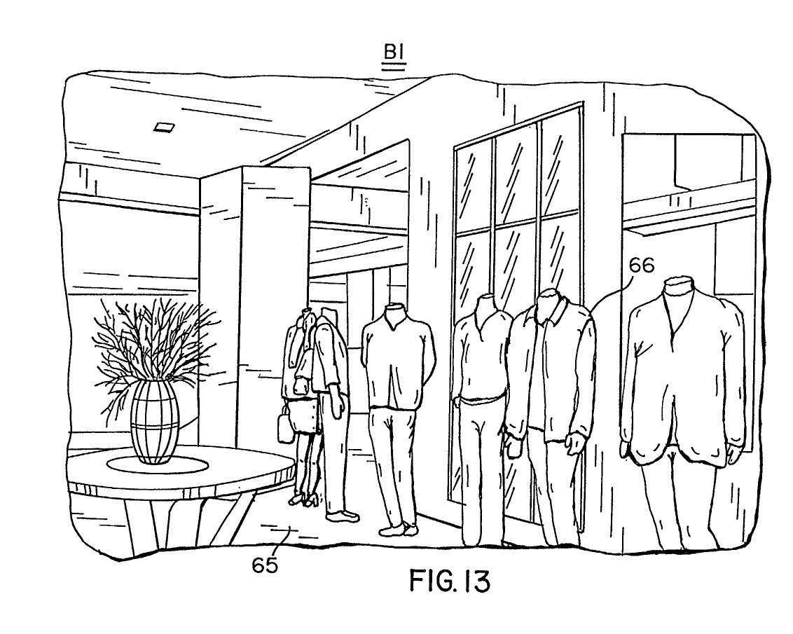

Proceeding to FIG. 13 there is provided a further illustration of the greater space and openness which is enabled upon the shopping floor 65 of the retail establishment. This, in many cases, will comprise only a single sample 66 of one piece of merchandise, as opposed to many racks and shelves of products. As may be appreciated, appropriate bar code tags, or bar code scanning capability, will be provided to the customers such that the above-described steps and options off of Steps B1/C2/D1 of the TOTALSHOP program may be accomplished. See FIG. 7 and 7A.

In FIG. 14 is shown the use of a large high def0inition LED display 68, used in lieu of mannequins or other display means, to provide to the customer a “larger than life” idea of the appearance of a given product as well as alternatives and coordinates thereto. That is, screens, not unlike those of FIG. 11, may appear upon walls within particular retail establishments. This would entail the additional benefit of providing to new customers a sense of the power and scope of the TOTALSHOP system.

With further reference to the impact of the present system upon the layout and configuration of the floor of a retail establishment, it is contemplated that clothing racks will be replaced by some combination of the mannequins shown in FIG. 13 and merchandise tables having thereon a limited amount of product but which, nonetheless, would enable the customer to touch, see and feel items before making a purchasing decision. In addition, shelving would be replaced by LED displays of the type above described with reference to FIG. 14 as well as the use of videos, large posters and photographs. Thereby, through the use of such a display strategy, there is achieved a reduction in quantity of sizes and color of any given item which must be kept in the inventory of a local store. However, as a trade-off, there is enabled the display of substantially increased variety and styles of items, both within each merchandise line per se and in numerous related or coordinated areas, many of which would be made known to the customer for the first time through Functions E3 through E6 of the TOTALSHOP system. Thereby, in this vision of “the store of the future” the quantity of on-site inventory is minimized in favor of a substantial increase in the scope and variety of merchandise, as well as in the design or aesthetic treatment of the interior of stores, in which only a small number of items of individual types of merchandise are required for on-floor display and/or touching by the customer.

As above noted, workstations 18 or 32, in accordance with the present system may be located upon the sales floor near to merchandise displays and may be located near so-called cashwrap locations within a given department. Further, as above related, workstations/cashwraps in accordance with the invention may be disposed within distinctively configured kiosks, one of which would be disposed within each major departments of the establishment.

It is also believed that the instant system will prove particularly suitable to group purchasing programs inasmuch as individual members of the group can input their purchasing preferences such that, through the use of a simple group preference analysis program, statistical preferences of a given group, in terms of such issues as style, color, pricing and delivery times, can be ascertained. This may be particularly significant with respect to large national organizations consisting of younger people as members. Further, the purchasing of such groups can be more efficiently met through the accessing of remotely distributed inventory drawn from a number of distribution centers of a retail organization. As such, in the present concept of “the store of the future,” delivery of product from central distribution centers would occur to a considerable greater extent thereby effecting savings in the cost of distribution to local retail outlets and effecting an increase in efficiency of delivery to the customer.

In addition, as above noted with reference to external log-on capability 48 (see FIG. 6) the present system also provides for off-site, e.g., Internet or other on-line access of the GUI to thereby enable a customer to determine such factors as local versus remote availability of given items as well as delivery periods and to secure access to all other capabilities of the system as set forth in Block E6 of the flow diagram of FIG. 7A. Thereby, there is accomplished an integration between hands-on retailing and Internet or home shopping, such that one using the present system at home or office can consider purchasing options prior to actually visiting the retail establishment to touch, see, and feel items of interest before making a final purchasing decision. The implications of the present system in terms of benefit to the retail shopper are obvious from the above. However, in accounting concept, the financial implications of the TOTALSHOP system may be defined in terms of an increase in the number of inventory turns per annum, that is, ratio or per annum sales to value of inventory on hand at any given point in time. More specifically, this ratio is, in the case of major retailers such as The May Company, Federated Department Stores, and JC PENNEY, in the neighborhood of 5.0, this meaning that such stores will typically sell out their entire inventory an average of five times per year. However, if an improvement in the number of turns per year in a range of five percent to fifteen percent could be accomplished, the financial implications for retailing would be remarkable as may be appreciated with reference to the following chart:

| | | | Federated | | | |
|---|---|---|---|---|---|---|
| | May | | Department | | JC | |
| | Company | | Store | | Penney | |
| 1998 Sales-to-Inventory | | | | | | |
| (turns) “Projected” 1998 | | | | | | |
| inventory turns. | | | | | | |
| if they were improved | | | | | | |
| | 5.05 | | 4.88 | | 4.92 | |
| 5% | 5.30 | | 5.12 | | 5.16 | |
| 10% | 5.55 | | 5.36 | | 5.41 | |
| 15% | 5.80 | | 5.61 | | 5.65 | |
| “Projected” 1998 Retail Sales | | | | | | |
| given inventory turns | | | | | | |
| improved: | | | | | | |
| 5% | $14.08 | B | $16.59 | B | $31.15 | B |
| 10% | $14.74 | B | $17.38 | B | $32.63 | B |
| 15% | $15.42 | B | $18.17 | B | $34.12 | B |
| Increased annual “Retail | | | | | | |
| Sales” given inventory turns | | | | | | |
| improved: | | | | | | |
| 5% | $66 | M | $76 | M | $1.50 | B |
| 10% | $1.33 | B | $1.55 | B | $2.98 | B |
| 15% | $2.00 | B | $2.34 | B | $4.46 | B |
| Increased Annual “Profit” | | | | | | |
| given turns improved: | | | | | | |
| 5% | $43 | M | $36 | M | $74 | M |
| 10% | $87 | M | $75 | M | $146 | M |
| 15% | $130 | M | $113 | M | $219 | M |

It may, thereby, be appreciated that a mere ten percent improvement, e.g., an improvement from 5.0 to 5.5 inventory turns a year on the part of a company such as The May Company, would result in an increase in annual sales of $1.3 billion dollars with a resultant increase in bottom line to such company of $87 million. Further, ten percent is a most conservative estimate of the potential of the TOTALSHOP system with reference to improvement in inventory turns. Accordingly, it is believed by the within inventor that the implications of the TOTALSHOP system are much greater than those indicated by the above chart.

While there has been shown and described the preferred embodiment of the instant invention it is to be appreciated that the invention may be embodied otherwise than is herein specifically shown and described and that, within said embodiment, certain changes may be made in the form and arrangement of the parts without departing from the underlying ideas or principles of this invention as set forth herein.

I claim:

1. A method of retail shopping including an establishment-specific intranet, the method comprising the steps of:
(a) assigning an establishment specific shopper profile to each customer and digitally expressing the same in an intranet access means;
(b) within a retail establishment, selecting a product search mode from the mode members consisting of:
(i) physically looking at a product on display;
(ii) observing a static, dynamic, or other pre-defined electronic image or series thereof including store department-specific product images; and
(iii) proceeding to an intelligent shopping station (ISS) comprising said establishment intranet and accessing said intranet with said intranet access means.
(c) if said step (b) (iii) is selected, employing said ISS to use and view a graphical user interface (GUI) thereof; and
(d) at said graphical user interface, accessing product specific information within searchable databases of said ISS, selected from suggestion categories consisting of product information, frequently asked questions about a consumer indicated product, alternatives to said indicated product, coordinates suitable therewith, and combinations thereof.

2. The method as recited in claim 1, in which said Step (d) of accessing of suggestion categories comprises the step of:
(e) sorting each category of suggestion in accordance with one or more criteria including geographical region, season, age of shopper, other personal data profile of the shopper, price range of interest, current discounts, and by random.

3. The method as recited in claim 2, further comprising the step of:
accessing said criteria of said suggestion categories in accordance with a selected store display site or department that is displayed on said GUI.

4. The method as recited in claim 2, further comprising the step of:
executing a zoom function upon any visually expressed suggestion of said sorting step (e) above.

5. The method as recited in claim 2, further comprising the step of:
arranging customer search results of said sorting step (e) in accordance with management defined priorities.

6. The method as recited in claim 2, further comprising the steps of:
(f1) if Step (b)(i) or (ii) above is selected, obtaining a bar code tag or element corresponding to a product of potential interest; and
(g1) bringing said tag to said ISS to consummate a sales transaction.

7. The method as recited in claim 2, further comprising the steps of:
(f2) if step (b)(i) or (ii) above is selected, determining a product of interest;
(f3) if said product is not in stock or is not in stock in the exact desired size, color or quantity, obtaining a bar code tag or element corresponding to said product; and
(g2) bringing said tag to said ISS to effect an on-line order of the exact desired product, in which offsite fulfillment means are employed by said ISS.

8. The method as recited in claim 2, further comprising the step of:
providing customer assistance at said ISS during any of said ISS use steps above.

9. The method as recited in claim 6, further comprising the step of:
providing customer assistance at said ISS during any of said ISS use steps above.

10. The method as recited in claim 7, further comprising the step of:
providing customer assistance at said ISS during any of said ISS use steps above.

11. The method as recited in claim 2, further comprising the step of:
positioning a fabric sample table near said electronic images and/or said ISS.

12. The method as recited in Step 2, further comprising the step of:
storing each customer product search for purposes of later external internet access through the use of said intranet access means of the customer.

13. The method as recited in claim 2 in which said intranet access means comprises a panel of credit card size and dimension.

14. The method as recited in claim 13 in which said panel comprises a retail store charge card.

15. The method as recited in claim 1, further comprising the step of:
accessing said criteria of said suggestion categories in accordance with selected store display sites or departments that are displayed on said GUI by random.

16. The method as recited in claim 15, in which said Step (d) of accessing of suggestion categories comprises the step of:
(e) sorting each category of suggestion in accordance with one or more criteria including geographical region, season, age of shopper, other personal data profile of the shopper, price range of interest, current discounts, and by random.

17. The method as recited in claim 15, further comprising the Step of:
click-or cursor-selecting a product of interest show in one of said store display sites upon said GUI; and
providing selectable information about said product.

18. The method as recited in claim 17, further comprising the step of:
executing a zoon function upon said selected product.

19. The method as recited in claim 17, further comprising the step of:
continuously providing views of product alternatives and/or coordinates to said selected product.

20. The system as recited in claim 18, further comprising the step of:
continuously providing views of product alternatives and/or coordinates to said selected product.
